(19) United States
(12) Patent Application Publication
(10) Pub. No.: US 2021/0075113 A1
(43) Pub. Date: Mar. 11, 2021

(54) ANTENNA

(71) Applicant: FUJIKURA LTD., Tokyo (JP)

(72) Inventors: Kaushal Shailendra, Sakura-shi (JP); Ning Guan, Sakura-shi (JP)

(73) Assignee: FUJIKURA LTD., Tokyo (JP)

(21) Appl. No.: 17/040,590

(22) PCT Filed: Mar. 25, 2019
(86) PCT No.: PCT/JP2019/012557

§ 371 Date: Sep. 23, 2020

(30) Foreign Application Priority Data
Mar. 30, 2018 (JP) 2018-066400

(51) Int. Cl. H01Q 9/04; H01Q 1/48; H01Q 21/00; H01Q 21/08

(52) U.S. Cl. CPC H01Q 9/0457; H01Q 21/08; H01Q 21/0006; H01Q 1/48

(57) ABSTRACT

To improve a gain of an antenna. An antenna 1 includes a dielectric layer 6, a conductive ground layer 7 bonded to the layer 6 and including active slots 7c-7f aligned at regular intervals, aligned active elements 9c-9f formed facing the active slots 7c-7f, respectively, first passive elements 9b, 9a aligned with and extending from one end of a row of the active elements 9c-9f, second passive elements 9g, 9h aligned with and extending from the other end of the row, a feed line 4a formed on a side opposite to the layer 7 with respect to the layer 6, to be electromagnetically coupled to the active elements 9c-9f via the active slots 7c-7f. The second passive elements 9g, 9h are arranged in line symmetry with the first passive elements 9b, 9a with respect to a line 9z passing through the center of the row and perpendicular to the row.

### TECHNICAL FIELD

The present disclosure relates to an antenna.

### BACKGROUND ART

Patent Literature 1 discloses an array antenna of a direct feeding system and a coplanar feeding system. The direct feeding system refers to a feeding system in which a feed line is directly connected to an antenna element. The coplanar feeding system refers to a feeding system in which a feed line and an antenna element are formed on a common plane.

As described in Patent Literature 1, a conductive ground layer is formed on one surface of a dielectric substrate, and a plurality of antenna elements and a plurality of feed lines are formed on the other surface of the dielectric substrate. The plurality of antenna elements are linearly aligned. The feed line extends from each of the antenna elements. Terminals of the feed lines extending from end antenna elements located at both ends of a row of the antenna elements are open, and the end antenna elements are passive elements. Terminals of the feed lines extending from middle antenna elements other than the end antenna elements are connected to a transmitter and receiver circuit, and the middle antenna elements are active elements. The passive elements at the both ends are provided to reduce a difference in directivity of the active elements.

### CITATION LIST

### Patent Literature

Patent Literature 1: Japanese Patent Application Publication No. 2017-46107

### SUMMARY OF INVENTION

### Technical Problem

Incidentally, it is desired to improve a gain of an antenna. Accordingly, the present disclosure has been achieved in view of the circumstances described above. An object of the present disclosure is to improve a gain of an antenna.

### Solution to Problem

A primary aspect of the present disclosure to achieve an object described above is an antenna comprising: a dielectric layer; a conductive ground layer bonded to the dielectric layer, the conductive ground layer including even-numbered active slots aligned at regular intervals; a plurality of active elements formed so as to face the active slots, respectively, the active elements aligned at regular intervals; one or more first passive elements aligned with and extending from one end of a row of the active elements; one or more second passive elements aligned with and extending from another end of the row of the active elements; and a feed line formed on a side opposite to the conductive ground layer with respect to the dielectric layer, the feed line configured to be electromagnetically coupled to the active elements via the active slots, the one or more second passive elements being arranged in line symmetry with the one or more first passive elements with respect to a line that passes through the center of the row of the active elements and is perpendicular to the row.

Other features of the present disclosure will become apparent from the following description and the drawings.

### Advantageous Effects of Invention

According to an embodiment of the present disclosure, it is possible to improve a gain of an antenna.

### BRIEF DESCRIPTION OF DRAWINGS

FIG. 1 is a plan view of an antenna according to an embodiment of the present disclosure.

FIG. 2 is a cross-sectional view thereof taken along line II-II of FIG. 1.

FIG. 3 is a graph illustrating a simulation result of a gain of an antenna according to the embodiment and a gain of an antenna according to a comparative example.

FIG. 4 is a graph illustrating a simulation result of a gain of an antenna with a passive slot and a gain of an antenna without a passive slot.

FIG. 5 is a graph illustrating a relationship between an inclination angle with respect to a normal line and a gain in a direction defined by the inclination angle.

FIG. 6 is a graph illustrating a simulation result of a gain of an antenna with an electrical length from a branch point of a feed line to immediately below a active slot being changed.

FIG. 7 is a cross-sectional view of an antenna according to another embodiment of the present disclosure.

FIG. 8 is a plan view of an antenna according to another embodiment of the present disclosure.

FIG. 9 is a plan view of an antenna according to another embodiment of the present disclosure.

FIG. 10 is a graph illustrating a simulation result of gains of antennas illustrated in FIGS. 1, 8, and 9.

FIG. 11 is a graph illustrating a simulation result of a gain of an antenna with the number of passive elements continued to both ends of a row of active elements being changed.

FIG. 12 is a graph illustrating a simulation result of a gain of an antenna.

FIG. 13 is a graph illustrating a simulation result of a gain of an antenna.

FIG. 14 is a graph illustrating a simulation result of a gain of an antenna.

FIG. 15 is a plan view of an antenna according to another embodiment of the present disclosure.

FIG. 16 is a graph illustrating a relationship between an inclination angle with respect to a normal line and a gain in a direction defined by the inclination angle when a phase difference between signal waves of feed lines adjacent to each other is −135°.

FIG. 17 is a graph illustrating a relationship between an inclination angle with respect to a normal line and a gain in a direction defined by the inclination angle when a phase difference between signal waves of feed lines adjacent to each other is −90°.

FIG. 18 is a graph illustrating a relationship between an inclination angle with respect to a normal line and a gain in a direction defined by the inclination angle when a phase difference between signal waves of feed lines adjacent to each other is 0°.

FIG. 19 is a graph illustrating a relationship between an inclination angle with respect to a normal line and a gain in a direction defined by the inclination angle when a phase difference between signal waves of feed lines adjacent to each other is 90°.

FIG. 20 is a graph illustrating a relationship between an inclination angle with respect to a normal line and a gain in a direction defined by the inclination angle when a phase difference between signal waves of feed lines adjacent to each other is 135°.

### DESCRIPTION OF EMBODIMENTS

At least the following matters will become apparent from the following description and the drawings.

An antenna will become apparent which comprises a dielectric layer; a conductive ground layer bonded to the dielectric layer, the conductive ground layer including even-numbered active slots aligned at regular intervals; a plurality of active elements formed so as to face the active slots, respectively, the active elements aligned at regular intervals; one or more first passive elements aligned with and extending from one end of a row of the active elements; one or more second passive elements aligned with and extending from another end of the row of the active elements; and a feed line formed on a side opposite to the conductive ground layer with respect to the dielectric layer, the feed line configured to be electromagnetically coupled to the active elements via the active slots, the one or more second passive elements being arranged in line symmetry with the one or more first passive elements with respect to a line that passes through the center of the row of the active elements and is perpendicular to the row.

As described above, the first passive elements are aligned with and extending from one end of the row of the active elements, and the second passive elements are aligned with and extending from the other end of the row of the active elements, thereby improving a gain of the antenna. Since the conductive ground layer is located between the feed line, and the active elements, the first passive elements, and the second passive elements, radiation of an electromagnetic wave in the feed line is less likely to affect radiation in the active elements, the first passive elements, and the second passive elements.

The conductive ground layer includes one or more first passive slots formed so as to face at least one of the first passive elements, and one or more second passive slots formed so as to face at least one of the second passive elements.

This improves a gain of an antenna.

The conductive ground layer includes the one or more first passive slots formed so as to face all of the one or more first passive elements, and the one or more second passive slots formed so as to face all of the one or more second passive elements.

This further improves a gain of an antenna.

The feed line branches at a point between the active slots adjacent to each other that are positioned in the center of the row of the active slots in plan view, the feed line having branch portions that extend from the point of branch until the branch portions cross the active slots at both ends of the row of the active slots in plan view, respectively.

A difference between an electrical length of a portion from the point of branch to one of the active slots adjacent to each other in plan view in the feed line and an electrical length of a portion from the point of branch to another of the active slots adjacent to each other in plan view in the feed line is equal to a quarter of an effective wavelength in the center of a band to be used.

This improves a gain of an antenna.

The antenna further comprises a dielectric substrate including a recess, wherein

the conductive ground layer is bonded to the dielectric substrate so as to cover the recess,

the active slots are arranged on an inner side with respect to the recess, and

the active elements, the first passive elements, and the second passive elements are formed on a bottom of the recess.

Accordingly, the recess results in becoming a hollow, and the hollow is interposed between the active elements and the active slots. This can reduce a dielectric loss when a signal wave is transmitted between the feed line and the active elements via the slots. Thus, a gain of the antenna is improved.

### Embodiments

Embodiments of the present disclosure will be described below with reference to the drawings. Note that various limitations that are technically preferable for carrying out the present disclosure are imposed on embodiments which will be described below, however, the scope of the disclosure is not to be limited to the following embodiments or illustrated examples.

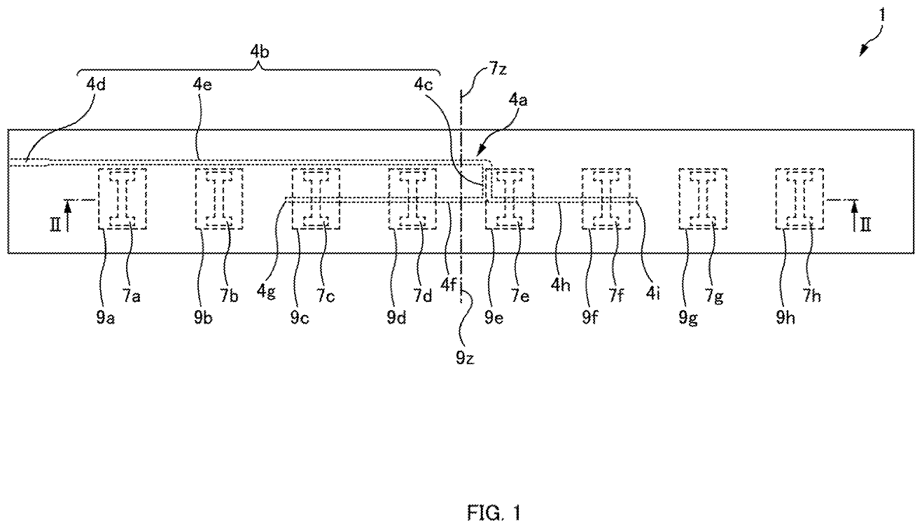

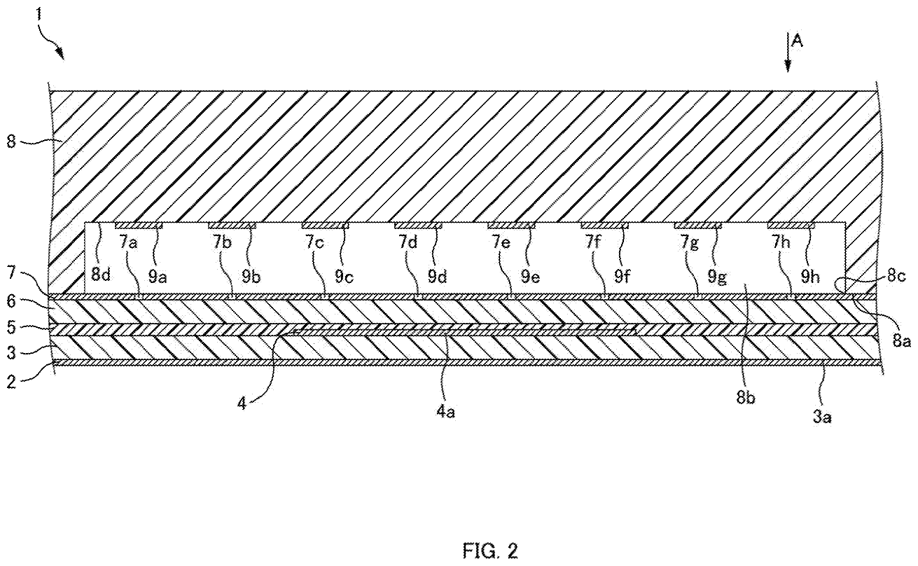

FIG. 1 is a schematic plan view of an antenna 1. FIG. 2 is a cross-sectional view thereof taken along line II-II of FIG. 1.

The antenna 1 is used for transmitting, receiving, or both transmitting and receiving a radio wave in a frequency band of a microwave or a millimeter wave.

A dielectric layer 3 and a dielectric layer 6 are bonded to each other, using a dielectric adhesive layer 5, with a conductive pattern layer 4 sandwiched therebetween. The dielectric layer 3 and the dielectric layer 6 are made of a liquid crystal polymer.

The conductive pattern layer 4 is formed between the dielectric layer 3 and the adhesive layer 5. Note that the conductive pattern layer 4 may be formed between the dielectric layer 6 and the adhesive layer 5.

A conductive ground layer 2 is formed on a surface 3a of the dielectric layer 3 on a side opposite to the conductive pattern layer 4 with respect to the dielectric layer 3.

The dielectric layer 6 and a dielectric substrate 8 are bonded to each other with a conductive ground layer 7 sandwiched therebetween. The dielectric layer 6 is bonded to the conductive ground layer 7 on a side opposite to the dielectric substrate 8 with respect to the conductive ground layer 7.

The conductive ground layer 7 is formed between the dielectric layer 6 and the dielectric substrate 8.

As described above, the conductive ground layer 2, the dielectric layer 3, the conductive pattern layer 4, the adhesive layer 5, the dielectric layer 6, the conductive ground layer 7, and the dielectric substrate 8 are laminated in this order. A laminated body from the conductive ground layer 2 to the conductive ground layer 7 is flexible, and the dielectric substrate 8 is rigid. Bending deformation of the antenna 1 is less likely to occur by virtue of the dielectric substrate 8 bonded to the laminated body that is from the conductive ground layer 2 to the conductive ground layer 7.

The thickness of the dielectric substrate 8 is greater than the thickness of each of the dielectric layers 3 and 6 and the adhesive layer 5, and is also greater than the total thickness of the dielectric layers 3 and 6 and the adhesive layer 5.

The conductive ground layer 2, the conductive pattern layer 4, and the conductive ground layer 7 are made of a conductive metal material such as copper.

The conductive ground layer 7 is processed and shaped by an additive method, a subtractive method, or the like, and thus a plurality of I-shaped slots 7a to 7h are formed in the conductive ground layer 7. Note that the shape of the slots 7a to 7h is not limited to the I shape, and may be a rectangular shape, a round shape, or other shapes.

Hereinafter, the slots 7a and 7b are referred to as first passive slots 7a and 7b, the slots 7c to 7f are referred to as active slots 7c to 7f, and the slots 7g and 7h are referred to as second passive slots 7g and 7h.

The active slots 7c to 7f are aligned at regular intervals in a short-side direction of the active slots 7c to 7f. The first passive slots 7b and 7a are aligned with and extending from one end of a row of the active slots 7c to 7f, and the second passive slots 7g and 7h are aligned with and extending from the other end of the row of the active slots 7c to 7f. Accordingly, the slots 7a to 7h are linearly aligned at regular intervals. A specific alignment order is the order of the slot 7a, the slot 7b, the slot 7c, the slot 7d, the slot 7e, the slot 7f, and the slot 7h from the left in FIG. 1.

Since the slots 7a to 7h are aligned at regular intervals, the first passive slot 7a and the second passive slot 7h are arranged in line symmetry with respect to a line 7z that passes through the center of the row of the active slots 7c to 7f and is perpendicular to the row. Similarly, the first passive slot 7b and the second passive slot 7g are arranged in line symmetry with respect to the line 7z.

The conductive pattern layer 4 is processed and shaped by an additive method, a subtractive method, or the like, and thus the conductive pattern layer 4 includes a feed line 4a. The feed line 4a is formed on a side opposite to the conductive ground layer 7 with respect to the dielectric layer 6, and is formed on the dielectric layer 3 on a side opposite to the conductive ground layer 2 with respect to the dielectric layer 3. Since the feed line 4a is located between the conductive ground layer 2 and the conductive ground layer 7, the feed line 4a constitutes a triplate or strip-line transmission line together with the conductive ground layer 2 and the conductive ground layer 7.

The feed line 4a is a line branching in a T-shape. The feed line 4a includes a main line portion 4b and branch line portions 4f and 4h.

The main line portion 4b is formed in an L shape.

The branch line portions 4f and 4h are formed by branching from one end portion 4c of the main line portion 4b at position between the active slots 7d and 7e adjacent to each other in the center of the row of the active slots 7c to 7f. The branch line portions 4f and 4h extend linearly in directions opposite to each other from a branch point. A direction in which the branch line portions 4f and 4h extend is parallel to a direction in which the active slots 7c to 7f are aligned.

The other end portion 4d of the main line portion 4b is connected to a terminal of a radio frequency integrated circuit (RFIC).

The width of the one end portion 4c and the other end portion 4d of the main line portion 4b is wider than the width of a portion 4e between the one end portion 4c and the other end portion 4d. Thus, the impedance of the one end portion 4c and the other end portion 4d of the main line portion 4b is smaller than the impedance of the portion 4e between the one end portion 4c and the other end portion 4d. For example, the impedance of the one end portion 4c and the other end portion 4d of the main line portion 4b is a half of the impedance of the portion 4e between the one end portion 4c and the other end portion 4d.

The width of the branch line portions 4f and 4h is smaller than the width of the one end portion 4c and the other end portion 4d of the main line portion 4b, and is equal to the width of the portion 4e between the one end portion 4c and the other end portion 4d. Thus, the impedance of the branch line portions 4f and 4h is greater than the impedance of the one end portion 4c and the other end portion 4d of the main line portion 4b. For example, the impedance of the branch line portions 4f and 4h is twice the impedance of the one end portion 4c and the other end portion 4d of the main line portion 4b.

The branch line portion 4f extends from the branch point until the branch line portion 4f crosses the active slots 7d and 7c in plan view, and the branch line portion 4f is open at one end 4g thereof. The impedance of a portion from the one end 4g to immediately below the active slot 7c in the branch line portion 4f is adjusted according to the length from the position facing the center of the active slot 7c to the one end 4g of the branch line portion 4f. Herein, the plan view refers to viewing the antenna 1 from above the antenna 1, in other words, viewing the antenna 1 in a direction of an arrow A illustrated in FIG. 2.

The branch line portion 4h extends from the branch point until the branch line portion 4h crosses the active slots 7e and 7f in plan view, and the branch line portion 4h is open at one end 4i thereof. The impedance of a portion from the one end 4i to immediately below the active slot 7f in the branch line portion 4h is adjusted according to the length from a position facing the center of the active slot 7f to the one end 4i of the branch line portion 4h.

The electrical length of the portion from the branch point of the feed line 4a to immediately below the active slot 7d is different from the electrical length of the portion from the branch point to immediately below the active slot 7e. Specifically, a difference between the electrical length of the portion from the branch point of the feed line 4a to immediately below the active slot 7d and the electrical length of the portion from the branch point to immediately below the active slot 7e is equal to a quarter of the effective wavelength in the center of a band to be used. This improves again of the antenna 1 (see Verification 4 described below). Note that a difference between the electrical length of the portion from the branch point to immediately below the active slot 7d and the electrical length of the portion from the branch point to immediately below the active slot 7e in the feed line 4a may be equal to a half of the effective wavelength in the center of a band to be used. The electrical length of the portion from the branch point to immediately below the active slot 7d in the feed line 4a may be equal to the electrical length of the portion from the branch point to immediately below the active slot 7e.

A recess 8b is formed in a bonding surface 8a, which is to be bonded to the conductive ground layer 7 out of two surfaces of the dielectric substrate 8. An opening 8c of the recess 8b faces the slots 7a to 7h, and the bonding surface 8a of the dielectric substrate 8 is bonded to the conductive ground layer 7. The opening 8c of the recess 8b is covered with the conductive ground layer 7, resulting in the recess 8b being a hollow. The slots 7a to 7h are arranged on the inner side with respect to the edge of the opening 8c of the recess 8b. A bottom 8d of the recess 8b faces the conductive ground layer 7. The bottom 8d of the recess 8b is flat, and is parallel to the conductive ground layer 7. The depth of the recess 8b, in other words, the height of the hollow is greater than the thickness of each of the dielectric layers 3 and 6 and the adhesive layer 5.

Patch-type first passive elements 9a and 9b, active elements 9c to 9f, and second passive elements 9g and 9h are formed on the bottom 8d of the recess 8b. The elements 9a to 9h are aligned at regular intervals in a direction parallel to the direction in which the slots 7a to 7h are aligned. Thus, the first passive element 9a and the second passive element 9h are arranged in line symmetry with respect to a line 9z that passes through the center of a row of the active elements 9c to 9f and is perpendicular to the row. Similarly, the first passive element 9b and the second passive element 9g are arranged in line symmetry with respect to the line 9z.

The first passive element 9a faces the first passive slot 7a. The first passive element 9b faces the first passive slot 7b. The active element 9c faces the active slot 7c. The active element 9d faces the active slot 7d. The active element 9e faces the active slot 7e. The active element 9f faces the active slot 7f. The second passive element 9g faces the second passive slot 7g. The second passive element 9h faces the second passive slot 7h. The active element 9c is configured to be electromagnetically coupled to the branch line portion 4f of the feed line 4a through the active slot 7c. The active element 9d is configured to be electromagnetically coupled to the branch line portion 4f of the feed line 4a through the active slot 7d. The active element 9e is configured to be electromagnetically coupled to the branch line portion 4h of the feed line 4a through the active slot 7e. The active element 9f is configured to be electromagnetically coupled to the branch line portion 4h of the feed line 4a through the active slot 7f. Accordingly, when the RFIC is a transmitter or a transceiver, signal waves transmitted from the RFIC using the feed line 4a are transmitted to the active elements 9c to 9f through the active slots 7c to 7f, respectively, and electromagnetic waves generated with the signal waves are radiated from the active elements 9c to 9f. When the RFIC is a receiver or a transceiver, signal waves generated with electromagnetic waves being incident on the active elements 9c to 9f are transmitted to the feed line 4a through the active slots 7c to 7f, respectively, and the signal waves are transmitted to the RFIC using the feed line 4a.

Herein, since the branch line portion 4f of the feed line 4a crosses the active slot 7c in plan view, impedance matching is achieved among the portion from the one end 4g to immediately below the active slot 7c in the branch line portion 4f, the active slot 7c, and the active element 9c. Since the branch line portion 4h of the feed line 4a crosses the active slot 7f in plan view, impedance matching is achieved among the portion from the one end 4i to immediately below the active slot 7f in the branch line portion 4h, the active slot 7f, and the active element 9f.

According to an embodiment according to the present disclosure as described above, the first passive elements 9b and 9a are aligned with and extending from one end of the row of the active elements 9c to 9f, and the second passive elements 9g and 9h are aligned with and extending from the other end of the row of the active elements 9c to 9f. The passive elements 9a, 9b, 9g, and 9h contribute to improvement in gain and widening of band of the antenna 1. This is verified by a simulation (see Verification 1 described below).

The rigid dielectric substrate 8 reduces bending of the laminated body that is from the conductive ground layer 2 to the conductive ground layer 7. Thus, reduction in thickness of the dielectric layers 3 and 6 and the adhesive layer 5 can be achieved. The reduction in thickness of the dielectric layers 3 and 6 and the adhesive layer 5 contributes to reduction in dielectric loss and improvement in radiation efficiency. Accordingly, a gain of the antenna 1 is high, and an applicable frequency band of the antenna 1 is wide.

A hollow formed with the recess 8b is present between the active elements 9c to 9f and the active slots 7c to 7f. A dielectric loss tangent in the hollow is substantially zero when the hollow is under an atmosphere of the air. Thus, a signal wave is not affected by a dielectric when the signal wave is transmitted between the active elements 9c to 9f and the active slots 7c to 7f, thereby being able to reduce occurrence of a dielectric loss. Accordingly, a gain of the antenna 1 is high, and an applicable frequency band of the antenna 1 is wide.

The passive elements 9a, 9b, 9g, and 9h face the passive slots 7a, 7b, 7g, and 7h, respectively. This contributes to improvement in gain and widening of the antenna 1. This is verified by a simulation (see Verification 2 described below).

Since the elements 9a to 9h are linearly aligned in a row, the antenna 1 has low directivity. In other words, the antenna 1 has not only high sensitivity in a normal direction, but also high sensitivity in a direction inclined to the row direction of the elements 9a to 9h with respect to the normal line. This is verified by a simulation (see Verification 3 described below).

Since the recess 8b is formed in the rigid dielectric substrate 8, the depth of the recess 8b (i.e., the height of the hollow) is less likely to change. Furthermore, a space between the elements 9a to 9h and the feed line 4a is also less likely to change. Thus, radiation characteristics of the antenna 1 is stabilized.

Since the conductive ground layer 7 is located between the elements 9a to 9h and the feed line 4a, radiation of an electromagnetic wave in the feed line 4a is less likely to affect radiation in the elements 9a to 9h.

### <Verification 1>

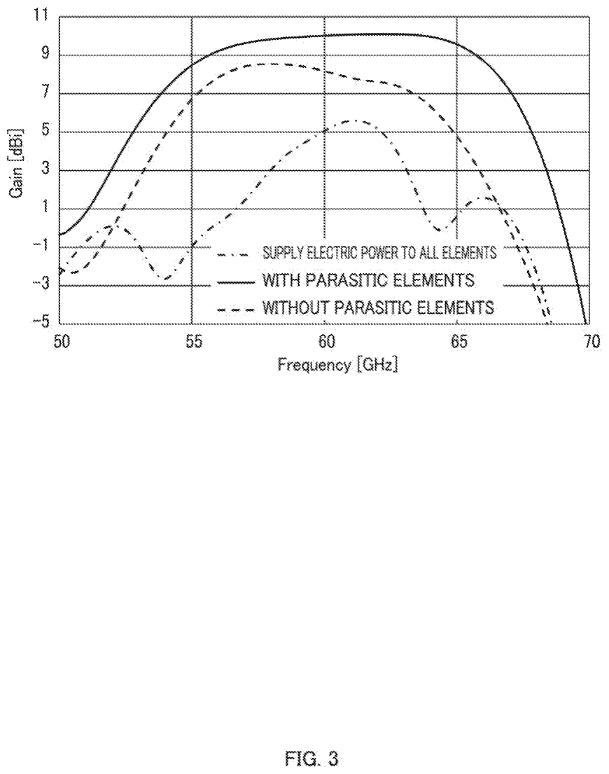

A contribution of the passive elements 9a, 9b, 9g, and 9h to improvement in radiation characteristics of the antenna 1 is verified by a simulation. A result of the simulation is illustrated in FIG. 3. The vertical axis represents a gain and the horizontal axis represents a frequency in a graph in FIG. 3. A solid line indicates a result using the antenna 1 as a simulation target. A broken line indicates a result using, as a simulation target, an antenna without the passive elements 9a, 9b, 9g, and 9h and the passive slots 7a, 7b, 7g, and 7h. A dashed-dotted line indicates a result using, as a simulation target, an antenna obtained by changing the passive elements 9a, 9b, 9g, and 9h into active elements such that the branch line portions 4f and 4h are extended from the one end portion 4c of the main line portion 4b until the branch line portions 4f and 4h cross the slots 7a and 7h, respectively, in plan view.

As apparent from FIG. 3, the antenna 1 including the passive elements 9a, 9b, 9g, and 9h and the passive slots 7a, 7b, 7g, and 7h has the highest gain. The antenna without the passive elements 9a, 9b, 9g, and 9h and the passive slots 7a, 7b, 7g, and 7h has a gain lower than that of the antenna 1 including the passive elements 9a, 9b, 9g, and 9h and the passive slots 7a, 7b, 7g, and 7h. The antenna obtained by changing the passive elements 9a, 9b, 9g, and 9h into the active elements has the lowest gain.

It is found from the foregoing simulation result that the passive elements 9a, 9b, 9g, and 9h contribute to improvement in radiation characteristics of the antenna 1.

### <Verification 2>

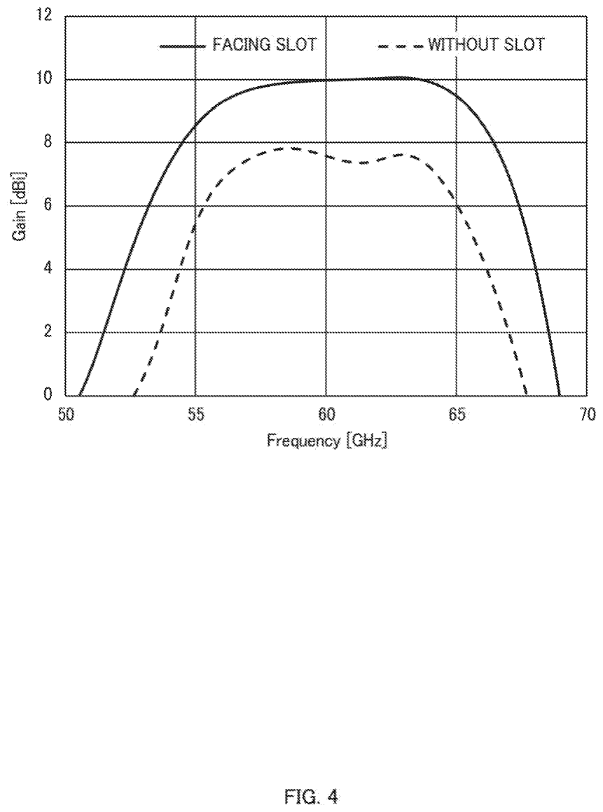

Improvement in radiation characteristics of the antenna 1 by virtue of the passive elements 9a, 9b, 9g, and 9h facing the passive slots 7a, 7b, 7g, and 7h, respectively, is verified by a simulation. A result of the simulation is illustrated in FIG. 4. The vertical axis represents a gain and the horizontal axis represents a frequency in a graph in FIG. 4. A solid line indicates a result using the antenna 1 as a simulation target. A broken line indicates a result using, as a simulation target, an antenna without the passive slots 7a, 7b, 7g, and 7h.

As apparent from FIG. 4, the antenna 1 provided with the passive slots 7a, 7b, 7g, and 7h has a gain higher than the antenna without the passive slots 7a, 7b, 7g, and 7h. Therefore, it is found that radiation characteristics of the antenna 1 are improved by virtue of the passive elements 9a, 9b, 9g, and 9h facing the passive slots 7a, 7b, 7g, and 7h, respectively.

### <Verification 3>

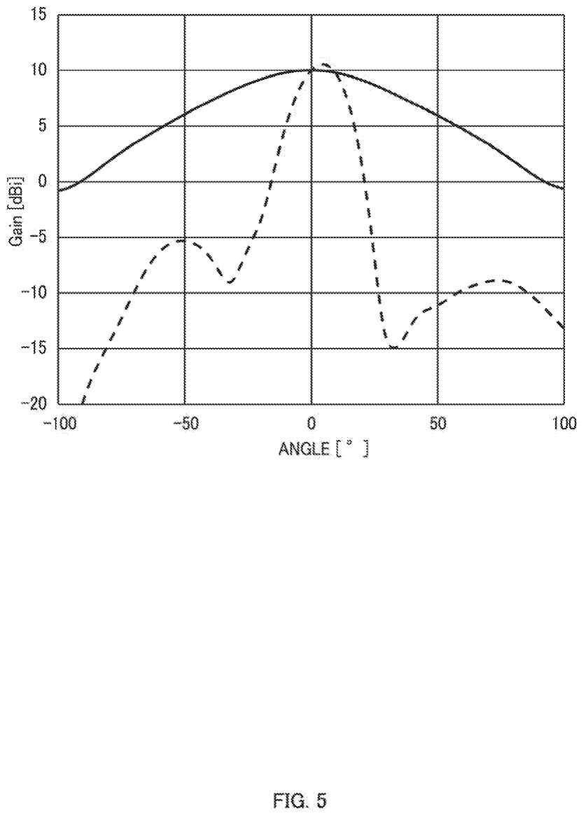

A simulation has been performed to verify that sensitivity in the direction inclined to the row direction of the elements 9a to 9h from the normal line is high by virtue of the elements 9a to 9h being linearly aligned in a row. A result of the simulation is illustrated in FIG. 5. The vertical axis represents a gain at 60 GHz and the horizontal axis represents an inclination angle with respect to the normal line in a graph in FIG. 5. In a solid line, the inclination angle represented by the horizontal axis indicates an angle inclined to the row direction of the elements 9a to 9h from the normal line. In a broken line, the inclination angle represented by the horizontal axis indicates an angle inclined to a direction orthogonal to the row direction of the elements 9a to 9h from the normal line.

It is apparent from the solid line in FIG. 5 that a gain does not greatly lower even when the angle inclined to the row direction of the elements 9a to 9h increases.

### <Verification 4>

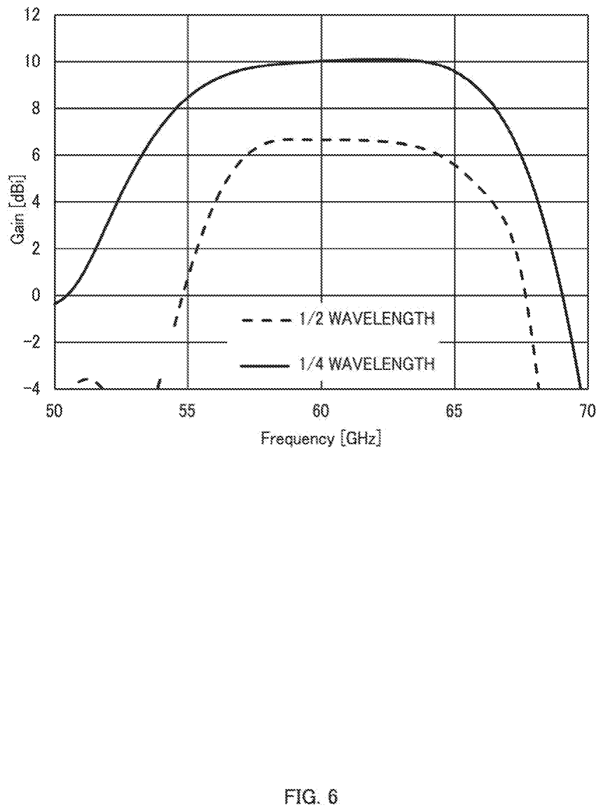

A gain of the antenna 1 has been simulated, and a result of the simulation is illustrated in FIG. 6. The vertical axis represents a gain and the horizontal axis represents a frequency in a graph in FIG. 6. A solid line is a simulation result when a difference between the electrical length of the portion from the branch point to immediately below the active slot 7d and the electrical length of the portion from the branch point to immediately below the active slot 7e in the feed line 4a is equal to a quarter of the effective wavelength in the center of a band to be used. A broken line is a simulation result when a difference between the electrical length of the portion from the branch point to immediately below the active slot 7d and the electrical length of the portion from the branch point to immediately below the active slot 7e in the feed line 4a is equal to a half of the effective wavelength in the center of a band to be used.

It is apparent from FIG. 6 that a gain of the antenna 1 is high when a difference between the electrical lengths is equal to a quarter of the effective wavelength in the center of the band to be used.

### Modification Examples

Next, some modifications from an embodiment described above will be explained. The modifications which will be described below can be applied separately or in combination.

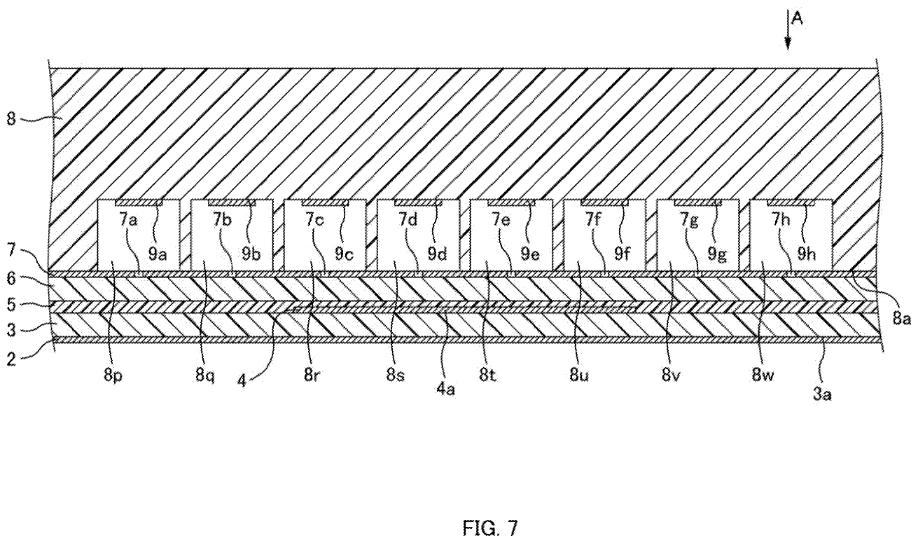

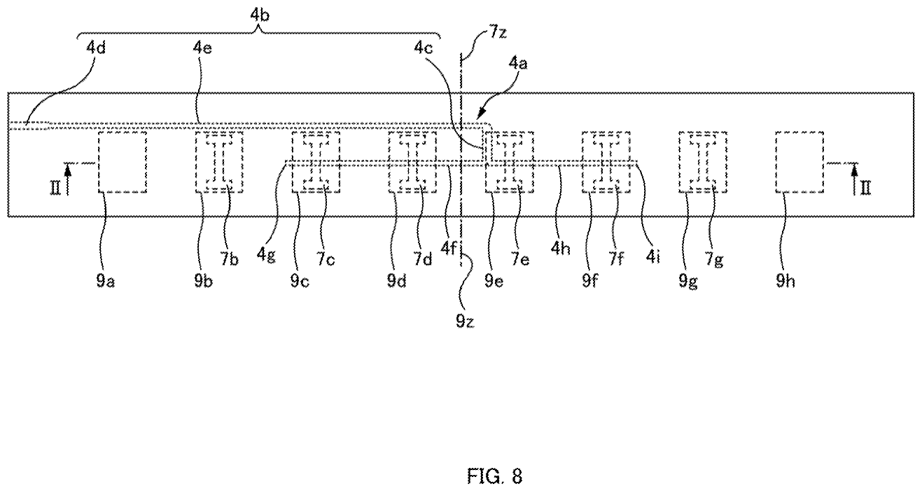

(1) In an embodiment described above, the elements 9a to 9h are arranged in the single recess 8b. In contrast, as illustrated in FIG. 7, the same number of recesses 8p to 8w as the number of the elements 9a to 9h may be formed in the bonding surface 8a of the dielectric substrate 8, and the elements 9a to 9h may be individually disposed in the recesses 8p to 8w, respectively. In this case, the elements 9a to 9h are individually formed on the bottoms of the recesses 8p to 8w, respectively, the slots 7a to 7h are individually arranged on the inner side with respect to the openings of the recesses 8p to 8w, respectively, and the elements 9a to 9h face the slots 7a to 7h, respectively. This improves strength of the dielectric substrate 8 by virtue of portions each between adjacent two of the recesses 8p to 8w, so that the dielectric substrate 8 is less likely to be deformed. Thus, radiation characteristics of the antenna 1 are stabilized.
(2) In an embodiment described above, the recess 8b is formed in the bonding surface 8a of the dielectric substrate 8, and the elements 9a to 9h are arranged in the recess 8b. In contrast, a dielectric may be interposed between the elements 9a to 9h and the slots 7a to 7h without forming the recess 8b. In other words, the recess 8b may be filled with a dielectric.
(3) In an embodiment described above, the elements 9a to 9h are disposed on the bottom 8d of the recess 8b. In contrast, a configuration may be such that a dielectric layer is formed on the conductive ground layer 7, the elements 9a to 9h are formed on the dielectric layer, and further a different dielectric substrate is bonded to the dielectric layer to cover the elements 9a to 9h.
(4) In an embodiment described above, the passive elements 9a, 9b, 9g, and 9h face the passive slots 7a, 7b, 7g, and 7h, respectively. In contrast, as illustrated in FIG. 8, the passive slots 7a and 7h may not be formed. In other words, the passive slots 7a and 7h may be filled with a conductor.

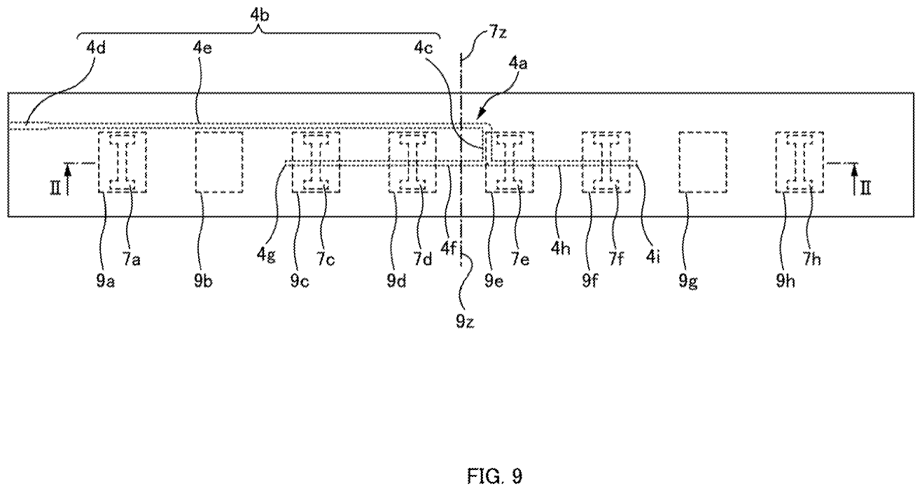

As illustrated in FIG. 9, the passive slots 7b and 7g may not be formed. In other words, the passive slots 7b and 7g may be filled with a conductor.

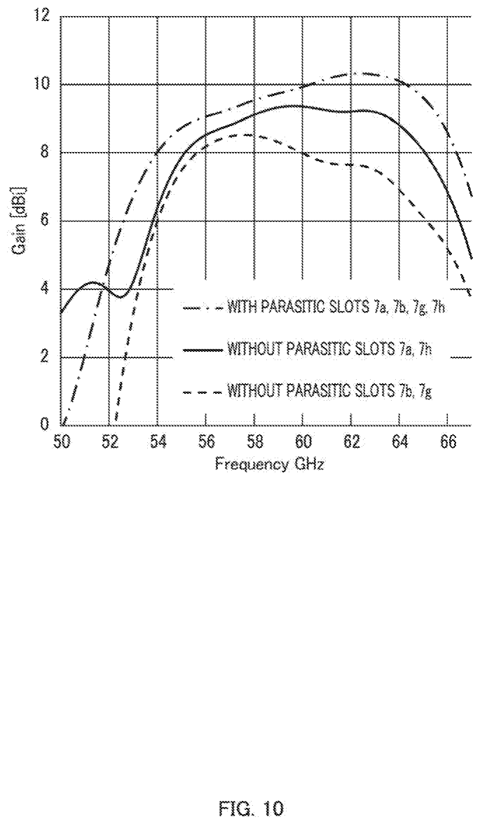

Herein, as illustrated in FIG. 8, when the passive slots 7b and 7g are formed without the passive slots 7a and 7h being formed, a gain of the antenna has been simulated. Furthermore, as illustrated in FIG. 9, when the passive slots 7a and 7h are formed without the passive slots 7b and 7g being formed, a gain of the antenna has been simulated. Results of the simulations are illustrated in FIG. 10. The vertical axis represents a gain and the horizontal axis represents a frequency in a graph in FIG. 10. A solid line indicates a result when the passive slots 7b and 7g are formed without the passive slots 7a and 7h formed, as illustrated in FIG. 8. A broken line indicates a result when the passive slots 7a and 7h are formed without the passive slots 7b and 7g being formed, as illustrated in FIG. 9. A dashed-dotted line indicates a result when the passive slots 7a, 7b, 7g, and 7h are formed. When these three cases are compared, a gain when the passive slots 7a, 7b, 7g, and 7h are formed, as illustrated in FIG. 1, is the highest, and a gain when the passive slots 7a and 7h are formed without the passive slots 7b and 7g being formed, as illustrated in FIG. 9, is the lowest.

(5) In an embodiment described above, the passive elements 9a, 9b, 9g, and 9h face the passive slots 7a, 7b, 7g, and 7h, respectively. In contrast, the passive slots 7a, 7b, 7g, and 7h may not be formed. In other words, the passive slots 7a, 7b, 7g, and 7h may be filled with a conductor.
(6) In an embodiment described above, the four active elements 9c to 9f are aligned between the first passive element 9b and the second passive element 9g, and the four active slots 7c to 7f are linearly aligned between the first passive slot 7b and the second passive slot 7g. In contrast, two, six, or more even-number of the active elements may be linearly aligned between the first passive element 9b and the second passive element 9g, and the same number of the active slots as the number of active elements may be aligned between the first passive slot 7b and the second passive slot 7g. In this case, the feed line 4a branches into two at a point between the active slots adjacent to each other in the center of the row of the slots in plan view, and the branch line portions 4f and 4h extend from the point of branch until the branch line portions cross the active slots at both ends of the row of the active slots in plan view.
(7) In an embodiment described above, the two first passive elements 9b and 9a are aligned with and extending from one end of the row of the active elements 9c to 9f, and the two second passive elements 9g and 9h are aligned with and extending from the other end of the row of the active elements 9c to 9f. In contrast, the single first passive element 9b may be aligned with and extending from the one end of the row of the active elements 9c to 9f without the first passive element 9a and the first passive slot 7a being provided. Similarly, the single second passive element 9g may be aligned with and extending from the other end of the row of the active elements 9c to 9f without the second passive element 9h and the second passive slot 7h being provided.

The three or more first passive elements may be aligned with and extending from the one end of the row of the active elements 9c to 9f, and the three or more second passive elements may be aligned with and extending from the other end of the row of the active elements 9c to 9f. In this case, the first passive slot and the second passive slot are set as in following (7a) or (7b).

(7a) The one or more first passive slots are formed so as to face at least one of the first passive elements, and the one or more second passive slots are formed so as to face at least one of the second passive elements.
(7b) The first passive slots are formed so as to face all of the first passive elements, respectively, and the second passive slots are formed so as to face all of the second passive elements, respectively.

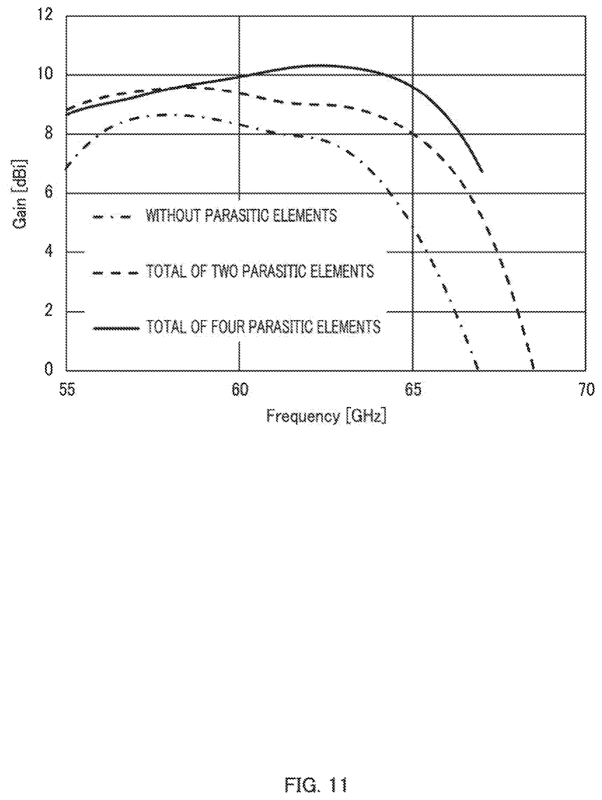

Herein, effects of the number of the first passive elements and the number of the second passive elements on a gain have been verified by a simulation. A result of the simulation is illustrated in FIG. 11. The vertical axis represents a gain and the horizontal axis represents a frequency in a graph in FIG. 11. A solid line indicates a simulation result when the passive elements 9a, 9b, 9g, and 9h and the passive slots 7a, 7b, 7g, and 7h are provided. A broken line indicates a simulation result when the passive elements 9b and 9g and the passive slots 7b and 7g are provided, without the passive elements 9a and 9h and the passive slots 7a and 7h being provided. A dashed-dotted line indicates a simulation result when the passive elements 9a, 9b, 9g, and 9h and the passive slots 7a, 7b, 7g, and 7h are not provided.

As apparent from FIG. 11, a gain of the antenna is the lowest when the passive elements 9a, 9b, 9g, and 9h and the passive slots 7a, 7b, 7g, and 7h are not provided. In contrast, a gain of the antenna 1 is higher when the two passive elements 9b and 9g and the two passive slots 7b and 7g are provided. Furthermore, a gain of the antenna 1 is the highest when the four passive elements 9a, 9b, 9g, and 9h and the four passive slots 7a, 7b, 7g, and 7h are provided.

(8) In an embodiment described above, the elements 9a to 9h are aligned at regular intervals. In contrast, when the intervals between the active elements 9c to 9f are set to P1 [mm], the interval between the passive element 9b and the active element 9c and the interval between the passive element 9g and the active element 9f are set to P2 [mm], and the interval between the passive element 9a and the passive element 9b and the interval between the passive element 9g and the passive element 9h is set to P3 [mm], P1, P2, and P3 may satisfy any relationship of following (a) to (d).

### (a) P1=P2, P2≠P3, P3≠P1

### (b) P1≠P2, P2≠P3, P3=P1

### (c) P1≠P2, P2=P3, P3≠P1

### (d) P1≠P2, P2≠P3, P3≠P1

Even in any case of (a) to (d) described above, the active elements 9c to 9f are aligned at regular intervals, the interval between the passive element 9b and the active element 9c is equal to the interval between the passive element 9g and the active element 9f, and the interval between the passive element 9a and the passive element 9b is equal to the interval between the passive element 9g and the passive element 9h.

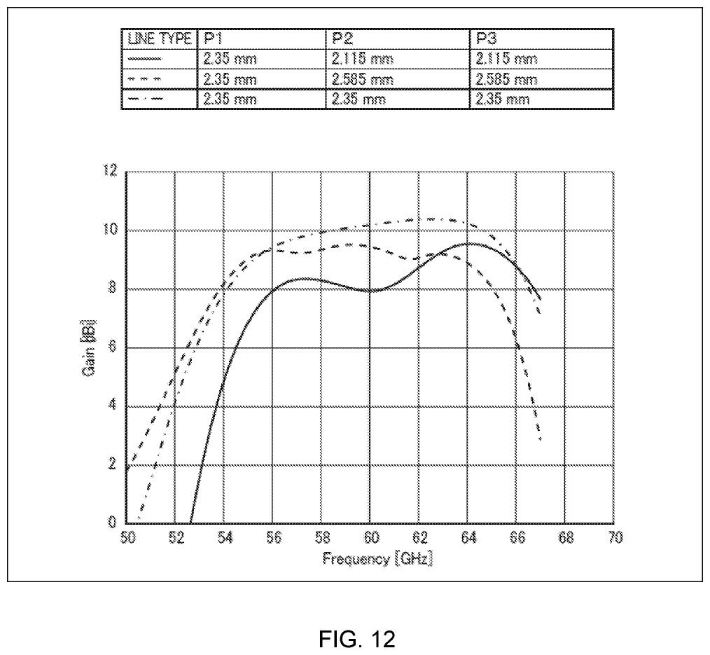

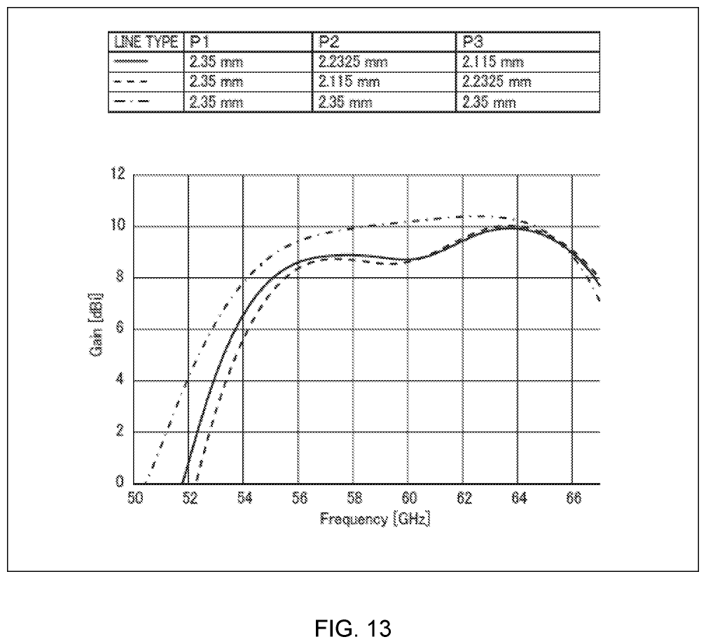

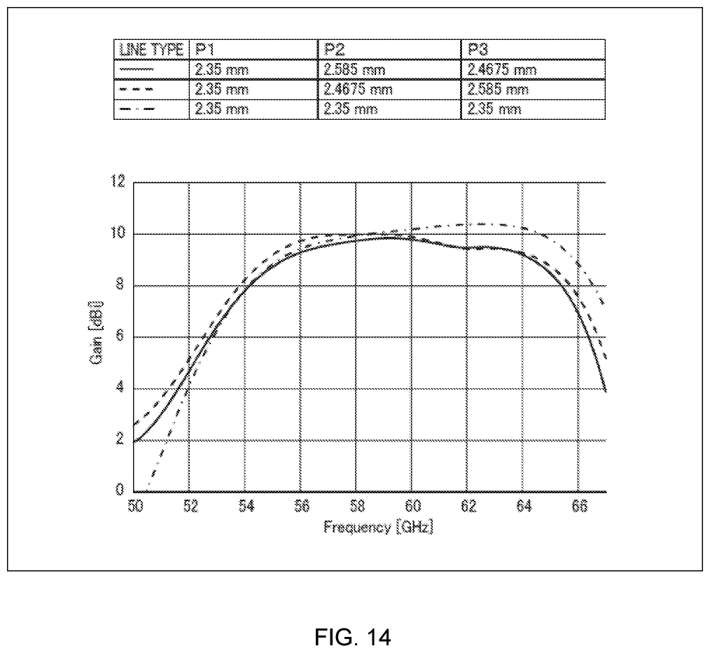

Herein, a gain has been simulated when the intervals between the elements 9a to 9h are set to such values as illustrated in tables. Results of the simulations are illustrated in FIGS. 12 to 14. The vertical axis represents a gain and the horizontal axis represents a frequency in each graph in FIGS. 12 to 14.

As apparent from FIGS. 12 to 14, gains (solid line and broken line in FIGS. 12 to 14) when the interval between the passive element 9b and the active element 9c and the interval between the passive element 9g and the active element 9f, and the interval between the passive element 9a and the passive element 9b and the interval between the passive element 9g and the passive element 9h are different from the intervals between the active elements 9c to 9f are not much different from a gain (dashed-dotted line in FIGS. 12 to 14) when the elements 9a to 9h are aligned at regular intervals.

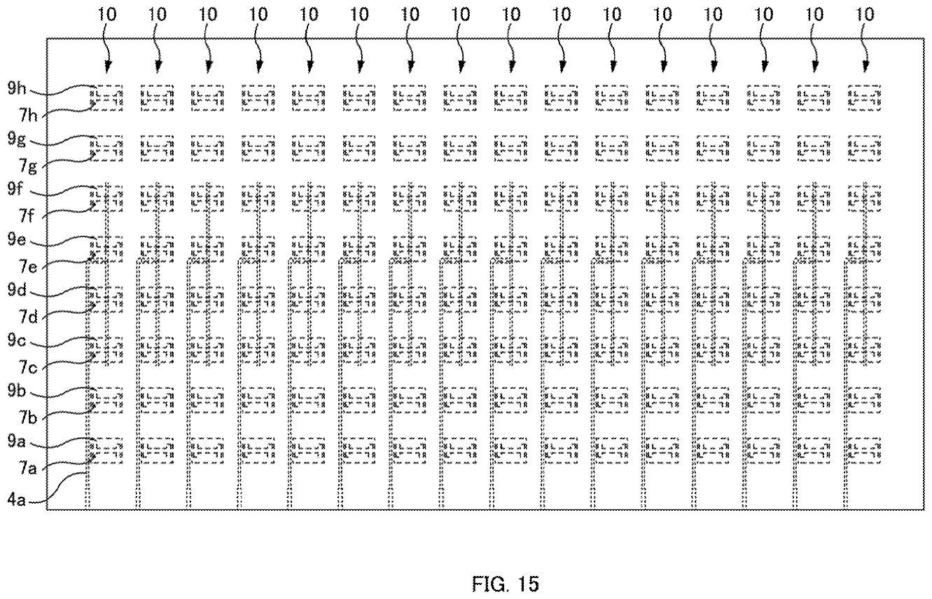

(9) In an embodiment described above, there is one group of the elements 9a to 9h, the slots 7a to 7h, and the feed line 4a. In contrast, as illustrated in FIG. 15, there may be a plurality of groups 10 each including the elements 9a to 9h, the slots 7a to 7h, and the feed line 4a. In this case, the plurality of groups 10 including the elements 9a to 9h, the slots 7a to 7h, and the feed line 4a are aligned in the direction orthogonal to the row direction of the elements 9a to 9h. The position in the row direction of the passive elements 9a in the groups 10 are aligned. The same applies to the elements 9b to 9h in the groups 10. The elements 9a to 9h in all of the groups 10 may be arranged in the single recess 8b. The elements 9a to 9h in each of the groups may be arranged in each recess 8b. The elements 9a to 9h may be individually arranged in the recesses, respectively. The directivity of an electromagnetic wave can be controlled by controlling the phase of a signal wave of each feed line 4a. This is verified by a simulation.

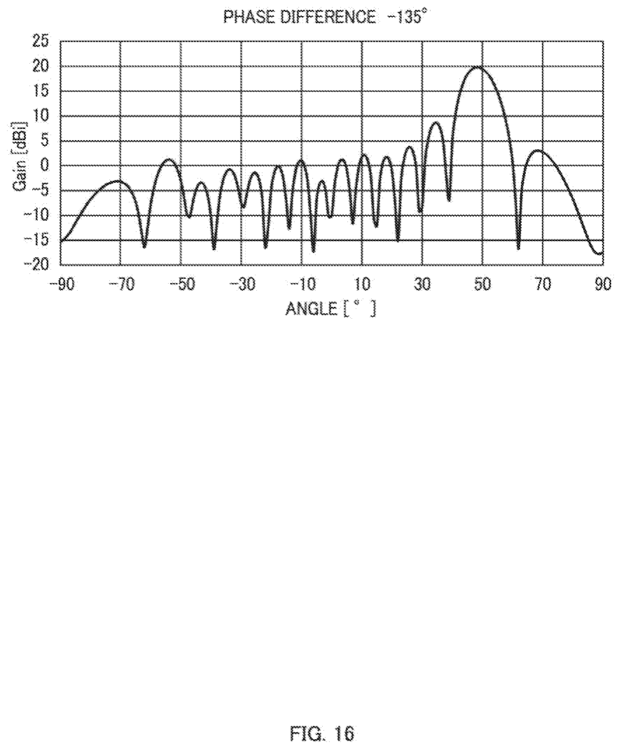

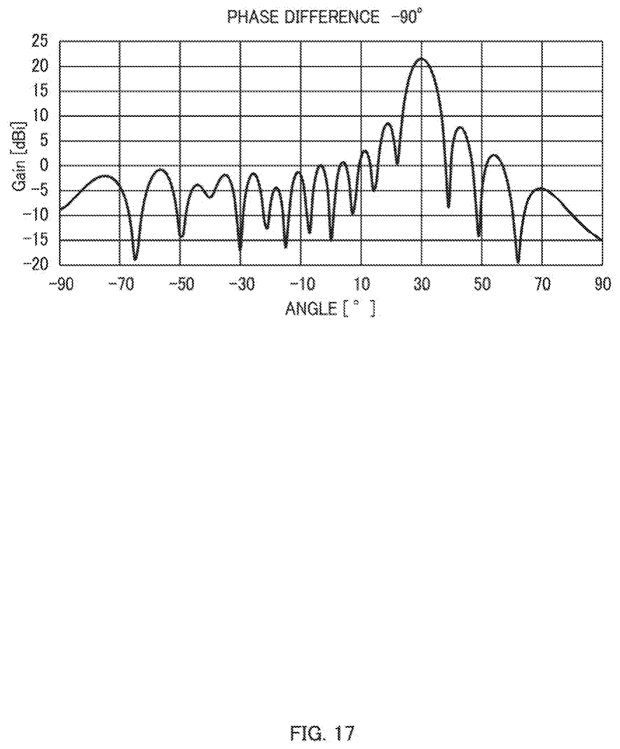

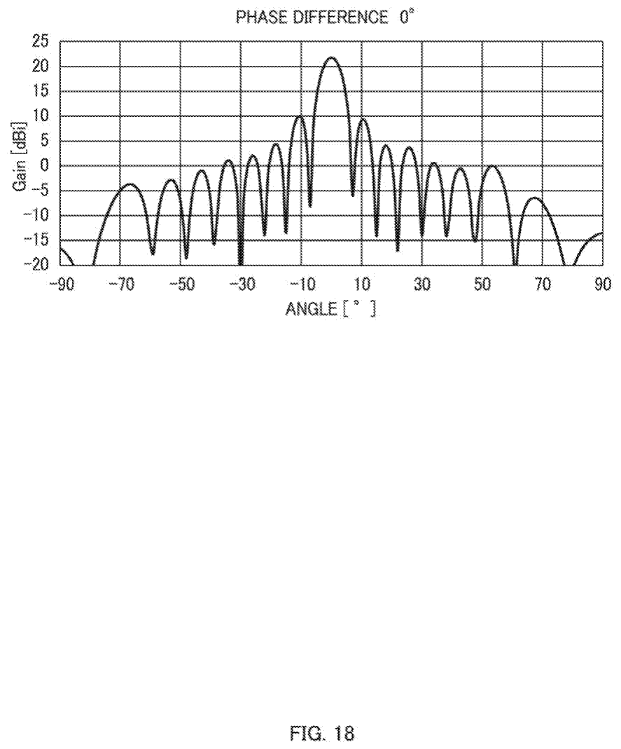

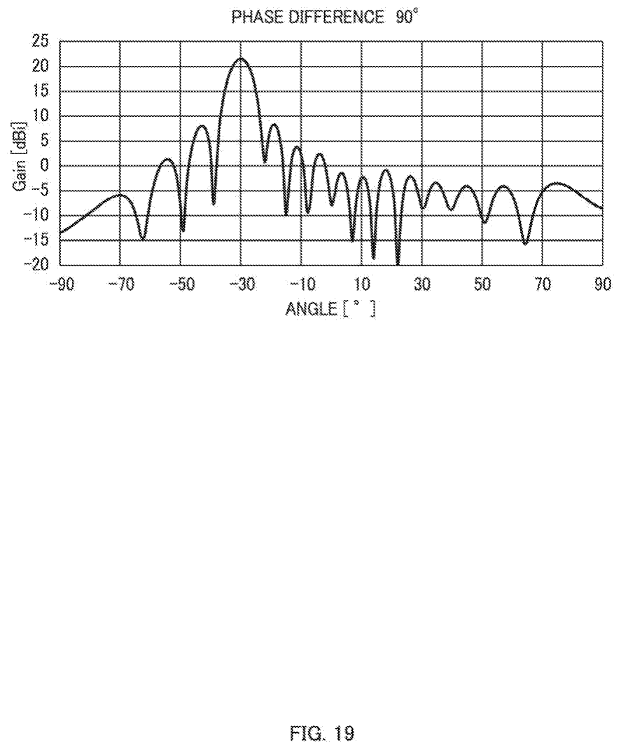

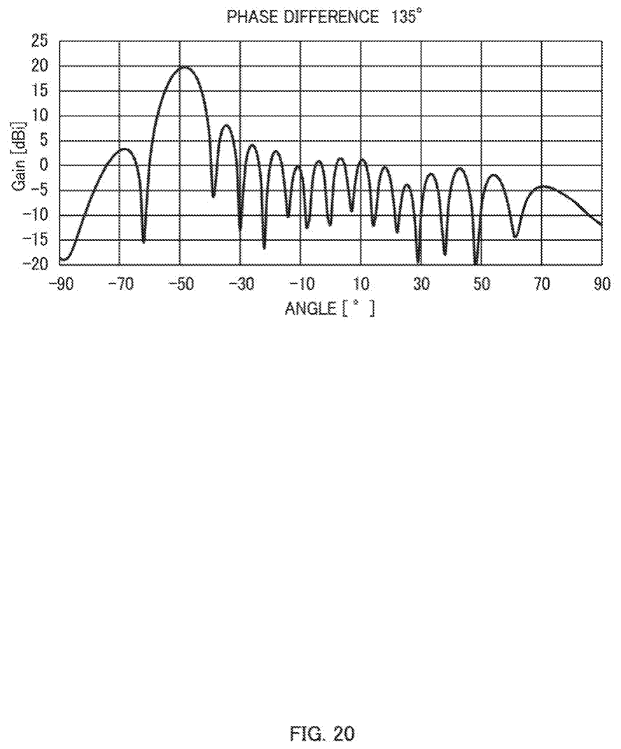

FIGS. 16 to 20 illustrate results when a phase difference between a signal wave of the other end portion 4d of each feed line 4a and a signal wave of the other end portion 4d of the feed line 4a adjacent thereto on the right in FIG. 15 is −135°, −90°, 0°, 90°, and 135°. The vertical axis represents a gain at 60 GHz and the horizontal axis represents an inclination angle with respect to the normal line in each graph in FIGS. 16 to 20. The inclination angle is an angle inclined to the direction orthogonal to the row direction of the elements 9a to 9h from the normal line. As illustrated in FIG. 18, when the phase difference is zero, directivity to the normal direction is high. As illustrated in FIGS. 16 to 20, as the absolute value of the phase difference increases, the direction in which sensitivity is high is inclined more with respect to the normal line. The maximum gain does not greatly change regardless of the phase difference.

### REFERENCE SIGNS LIST

1 antenna
4a feed line
6 dielectric layer
7 conductive ground layer
7a, 7b first passive slot
7c, 7d, 7e, 7f active slot
7g, 7h second passive slot
8 dielectric substrate
8b recess
8d bottom of recess
9a, 9b first passive element
9c, 9d, 9e, 9f active element
9g, 9h second passive element

1. An antenna comprising:
a dielectric layer;
a conductive ground layer bonded to the dielectric layer, the conductive ground layer including even-numbered active slots aligned at regular intervals;
a plurality of active elements formed so as to face the active slots, respectively, the active elements aligned at regular intervals;
one or more first passive elements aligned with and extending from one end of a row of the active elements;
one or more second passive elements aligned with and extending from another end of the row of the active elements; and
a feed line formed on a side opposite to the conductive ground layer with respect to the dielectric layer, the feed line configured to be electromagnetically coupled to the active elements via the active slots,
the one or more second passive elements being arranged in line symmetry with the one or more first passive elements with respect to a line that passes through the center of the row of the active elements and is perpendicular to the row.

2. The antenna according to claim 1, wherein,
the conductive ground layer includes one or more first passive slots formed so as to face at least one of the first passive elements, and one or more second passive slots formed so as to face at least one of the second passive elements.

3. The antenna according to claim 2, wherein,
the conductive ground layer includes the one or more first passive slots formed so as to face all of the one or more first passive elements, and the one or more second passive slots formed so as to face all of the one or more second passive elements.

4. The antenna according to claim 1, wherein
the feed line branches at a point between the active slots adjacent to each other that are positioned in the center of the row of the active slots in plan view, the feed line having branch portions that extend from the point of branch until the branch portions cross the active slots at both ends of the row of the active slots in plan view, respectively.

5. The antenna according to claim 4, wherein
a difference between an electrical length of a portion from the point of branch to one of the active slots adjacent to each other in plan view in the feed line and an electrical length of a portion from the point of branch to another of the active slots adjacent to each other in plan view in the feed line is equal to a quarter of an effective wavelength in the center of a band to be used.

6. The antenna according to claim 1, further comprising
a dielectric substrate including a recess, wherein
the conductive ground layer is bonded to the dielectric substrate so as to cover the recess,
the active slots are arranged on an inner side with respect to the recess, and
the active elements, the one or more first passive elements, and the one or more second passive elements are formed on a bottom of the recess.
